(19) United States
(12) Patent Application Publication
(10) Pub. No.: US 2006/0096151 A1
(43) Pub. Date: May 11, 2006

(54) Electro fish alert

(76) Inventors: John P. Zazzara SR., So. Plainfield, NJ (US); James J. Denker, Monmouth Beech, NJ (US)

Correspondence Address: JOHN P. ZAZZARA SR., 203 OAKMANOR PKWY, SO. PLAINFIELD, NJ, 07080, US

(21) Appl. No.: 10/984,983

(22) Filed: Nov. 10, 2004

(51) Int. Cl. A01K 97/12

(52) U.S. Cl. 43/17

(57) ABSTRACT

An electronic ice fishing signaling device comprising of a circular frame member with three arms positioned in a star configuration and adapted to be supported in an upright position in an ice hole in an operative position. Support means are pivotally mounted legs attached to the support arms which are, adjustable to span an ice hole and support the circular frame member in an upright position. An actuator rod is pin mounted to the circular frame member and has a crank operated reel at the end thereof and positioned thereon to be above water when the circular frame member is in an operative position. A switch tripper is attached to the actuator rod at the upper end thereof, and is rotatable essentially ninety degrees to an armed position and will rotate downward when released from the armed position. A microswitch is mounted to the actuator rod end under the switch tripper when said column member is in an operative position. The actuator rod has a FM transmitter at the end thereof. When rotated by pay-out of line from the reel the actuator rod will release the switch tripper and the activate the microswitch. The microswitch is activated when the switch tripper is rotated ninety degrees and the FM transmitter signals a remote receiver.

### FIELD OF THE INVENTION

This invention relates to an ice fishing device and more particularly a normally unattended device that provides both a visual and audio signal and optional FM transmitter connection which signals when a fish takes the hook and pulls off line.

### BACKGROUND OF THE INVENTION

Ice fishing is a very popular winter activity in many areas where lakes or ponds freeze over in the winter to a depth sufficient to support humans. It is customary for the ice fisherman to cut a hole in the ice and insert tackle in the water in one or more places and then attempt to keep warm. The various gear used by ice fishermen usually includes a visual signaling device which is activated when a fish hits and starts to pull out line. These devices are commonly known as tip-ups.

These devices, when operatively positioned, generally comprise an upright column member having an essentially perpendicular support member that bridges the hole in the ice. A reel is positioned on the column member and immersed in the water. A flexible signaling mast is carried at or adjacent the top of the column member and bent over and held by a retainer in a retracted position until line is pulled from the reel. An actuator member is rotatably carried on or in the column member. The actuator member is rotated by a cam on the reel and upon rotation will release the flexible member from its retainer. Usually a flag is positioned on the end of the flexible member for increased visibility. The actuator member is enclosed in a sleeve between the reel and the retainer. Problems occur when water freezes in this sleeve and the actuator cannot rotate. The generally accepted technique of preventing freeze up of the actuator rod in the sleeve is to provide a low temperature lubricant in the sleeve.

The present invention provides a new and improved arrangement for the actuator rod that prevents freeze up and does not require a lubricant. The present invention further provides a tip-up of simplified construction where the actuator rod is also the retainer for the electronic signaling mast

An object of this invention is to provide a new and improved tip-up of the type described.

Another object of this invention is to provide a new and improved tip-up of the type described which has a minimal number of parts and is economical in construction.

A further object of this invention is to provide a tip-up of new and improved construction which eliminates the problem of ice impeding the operation of the actuator rod member.

### SUMMARY OF THE INVENTION

An electronic ice fishing signal device comprising of a circular frame member with three arms positioned in a star configuration and adapted to be supported in an upright position in an ice hole in an operative position. Support means are pivotally mounted legs attached to the support arms that are, adjustable to span an ice hole and support the circular frame member in an upright position. An actuator rod is pin mounted to the circular frame member and has a crank operated reel at the end thereof and positioned thereon to be above water when the circular frame member is in an operative position. A switch tripper is attached to the actuator rod at the upper end thereof, and is rotatable essentially ninety degrees to an armed position and will rotate downward when released from the armed position. A microswitch is mounted to the actuator rod end under the switch tripper when said column member is in an operative position. The actuator rod has a FM transmitter at the end thereof. When rotated by pay-out of line from the reel the actuator rod will release the switch tripper and the activate the microswitch. The microswitch is activated when the switch tripper is rotated ninety degrees and the FM transmitter signals a remote receiver.

The invention is particularly pointed out and distinctly claimed in the concluding portion of this specification. The invention, however, together with further objects and advantages thereof, may be best appreciated by reference to the following detailed description taken in conjunction with the drawings

### BRIEF DESCRIPTION OF THE DRAWINGS

FIG. 1 is a side environmental view of ice fishing device or tip-up embodying the invention shown.

FIG. 2 is a top environmental view of the tip-up of FIG. 1 showing the support arms extended.

FIG. 3 is a front elevation of the tip-up support leg.

FIG. 4 is a side elevation of the tip-up support leg.

FIG. 5 is a side environmental partially cut-away view of a tip-up actuator rod assembly embodying the invention shown.

### DETAILED DESCRIPTION OF PREFERRED EMBODIMENT OF THE INVENTION

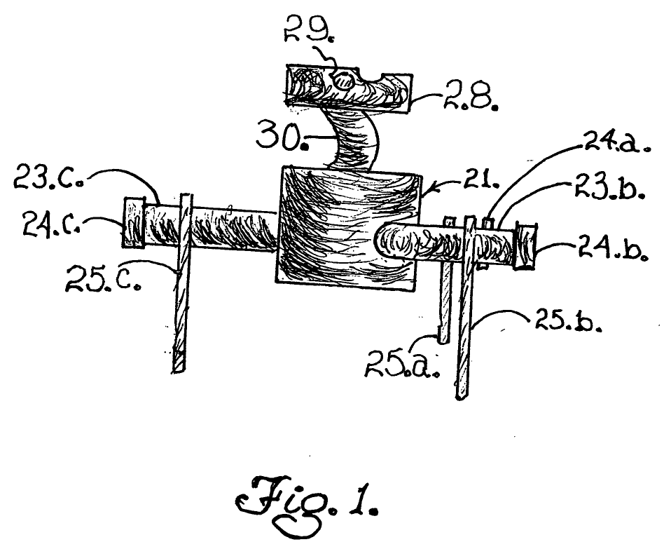

Referring to FIG. 1. An ice fishing device or tip-up embodying the invention in an operative mode comprises an circular frame base 21 with 3 cross support members 23a, 23b, and 23c extended in a star topology. The actuator rod 28 is supported by a pin mounted bracket 29. that is anchored to the circular frame member by a vertical column member 30. Leg support members 25a, 25b and 25c elevate the device above the fishing hole and are adjustable along each cross support member 23a, 23b and 23c to the size of the ice hole. Each end cap 24a, 24b and 24c act as a stop for the adjustable leg support members.

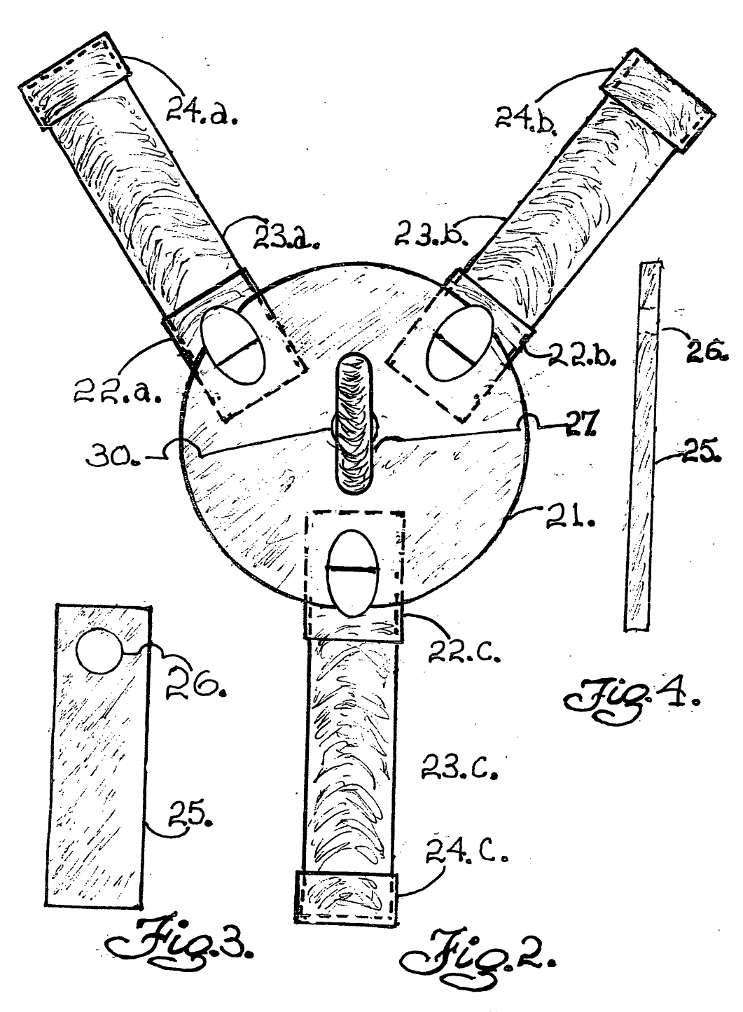

Referring to FIG.2. each cross support member or arm end 23a, 23b and 23c is permanently anchored in to the circular frame member 21. The actuator rod 27 is attached to the circular frame member 21 by a column support 30. Each cross support member or arm is capped at the free end with pcv end caps 24a, 24b and 24c. The cross support members 23a, 23b and 23c are sleeve mounted 22a, 22b and 22c into the circular frame member.

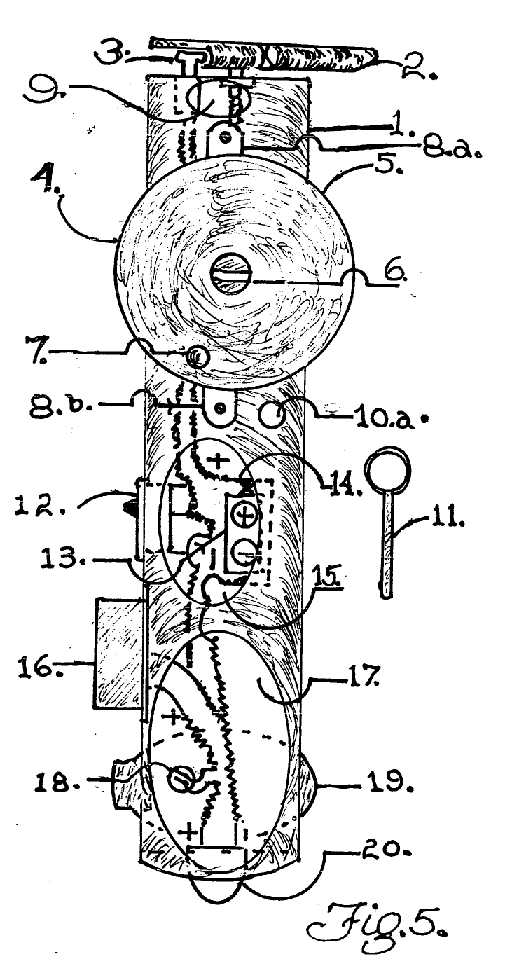

Referring to FIGS. 3-4 the support legs 25 contain a cutout 26 at the top end of equal diameter as the cross support member outside diameter.

Referring to FIG. 5., the actuator rod assembly 1 contains 15 components. The top end of the actuator rod assembly 1 consist of a switch tripper 2 which connects to a internally mounted micro switch 3 which is connected to the (+) side power switch 12. The actuator rod assembly has a reel assembly 4,5,6 and 7 mounted on the side of the actuator rod assembly. The reel assembly is anchored to the actuator rod assembly through 2 support brackets 8a and 8b. The actuator rod assembly 1 is pin 11 mounted to the circular frame member through a mounting hole 10a drilled through the rod assembly.

Operation of the electronic ice fishing signal device is initiated by the top mounted slide switch assembly 12., that is connected to the (+) side of the 12 volt power source 13. Internal wiring of the 12v power source and the audio alert device 16 is shown by cutouts 14 and 15. The negative side of the 12v power source connects to the visual alert device 20 and the (−) side if the on/off switch 12. The ice fishing device 1 also contains a micro connector 18 to facilitate connection to an optional FM transmitter (not shown).

What is claimed is:

1. An electronic ice fishing signaling device comprising:
a circular frame member adapted to be supported in an upright position in an ice hole in an operative position;
support arms mounted to said circular frame member in a star topology with rotatably mounted legs adapted to span an ice hole and support said column member in an upright position;
a actuator rod member mounted to said circular frame member and positioned thereon to be above water when said circular frame member is in an operative position;

2. The device of claim 1 wherein said actuator rod assembly comprises;
a pin mounted reel attached to said actuator rod and positioned thereon to be above water when said circular frame member is in an operative position;
a LED mounted in the said actuator rod member at the free end thereof,
a switch tripper mounted at the upper end of the actuator rod assembly ,said switch tripper being rotatable essentially ninety degrees to an armed position;
a FM Transmitter mounted at the free end of the actuator rod assembly;
a slide double pole single throw switch mounted in top of said actuator rod assembly;

3. The device of claim 2 wherein the upper end of said actuator rod member is formed as signaling mast trigger for the said optional remote sensor device. Said signaling mast trigger consisting of rotatable switch trigger and internally mounted microswitch.

4. An electronic ice fishing signaling device comprising:
a circular frame member adapted to be supported in an upright position in an ice hole in an operative position;
support arms mounted to said circular frame member in a star topology with rotatably mounted legs adapted to span an ice hole and support said column member in an upright position;
a actuator rod member mounted to said circular frame member and positioned thereon to be above water when said circular frame member is in an operative position;
a audio alert buzzer activated by said upper end mounted micro switch assembly;
an internally mounted 12v power source;

5. The device of claim 4, wherein said means for signaling consist of said mini connector located at end of said actuator rod forming said signaling mast.
